(19) United States
(12) Patent Application Publication
(10) Pub. No.: US 2022/0147920 A1
(43) Pub. Date: May 12, 2022

(54) SYSTEM AND METHOD FOR AUTOMATICALLY GENERATING MANIFEST INFORMATION FOR SHIPMENTS

(71) Applicant: Simpler Postage, Inc., San Francisco, CA (US)

(72) Inventors: Bardia Keyoumarsi, Oakland, CA (US); Andrew Tribone, HI (US)

(21) Appl. No.: 17/096,365

(22) Filed: Nov. 12, 2020

(51) Int. Cl. G06Q 10/08; G06F 9/54

(52) U.S. Cl. CPC G06Q 10/0833; G06F 9/541; G06Q 10/0832

(57) ABSTRACT

Systems and methods for automatically generating manifest information for shipments. Shipping labels are automatically assigned to groups, based on one or more label attributes. Manifest information is automatically generated for one or more groups of shipping labels.

### TECHNICAL FIELD

This disclosure relates generally to the shipping logistics field, and more specifically to a new and useful system and method for managing shipping logistics using a shipping services software platform.

### BACKGROUND

In the shipping logistics field, some shipping carriers require shippers to provide a list of shipments that are to be picked up by the shipping carrier and delivered to respective shipping designations. Such a list of shipments is sometimes referred to as a manifest. A manifest typically includes one or more of the following types of information for shipments included in a manifest: recipient name, shipping service, tracking numbers, package details, shipping date, and other information. As an example, the United States Postal Service (USPS) requires manifests when shipping large numbers of packages. By providing a manifest, a shipping carrier can scan the manifest to check-in all shipments included in the manifest.

### BRIEF DESCRIPTION OF THE FIGURES

FIGS. 1A and 1B are schematic representations of a system, in accordance with embodiments.

FIG. 1C is a representation of data stored by the system, in accordance with embodiments.

FIGS. 2A-C and 3A-B are schematic representations of the method, in accordance with embodiments.

FIGS. 4A-B are exemplary representations of manifest information generation, in accordance with embodiments.

### DESCRIPTION OF THE PREFERRED EMBODIMENTS

The following description of the preferred embodiments is not intended to limit the disclosure to these preferred embodiments, but rather to enable any person skilled in the art to make and use such embodiments.

### 1. Overview.

Generating a manifest can be cumbersome, and often requires a significant amount of work. For example, to generate a manifest, shipping customers typically keep track of shipments that need to be manifested, and record any manifest-related parameters for each shipment. In some cases, an improperly generated manifest can cause shipping delays, as a carrier might refuse to deliver shipments if they are not properly manifested (according to the requirements of the shipping carrier).

The system and method disclosed herein relate to automatically generating manifest information for shipments.

The method can include: automatically assigning shipping labels data objects to shipping label groups, based on one or more shipping label attributes; and automatically generating shipping manifest information for one or more shipping label groups. A shipping label data object can be assigned to a shipping label group automatically after the shipping label is generated. Data for each shipping label group can be stored and used to automatically generate shipping manifest information. Data stored for a shipping label group can include one or more shipping label attributes (and optionally attributes of at least one associated shipping facility). Shipping manifest information for a shipping label group can be generated in accordance with configuration stored for at least one shipping facility for shipping label data objects included in the shipping label group. Optionally, a shipping label data object can be assigned to a shipping label group in accordance with manifest requirements stored for at least one shipping carrier for shipping label data objects included in the shipping label group.

At least one component of the system performs at least a portion of the method. The system can be a shipping services platform, or any suitable system that has access to data needed to automatically generate manifest information.

### 2. Benefits.

Variations of this technology can afford several benefits and/or advantages.

First, by automatically assigning shipping label data objects to shipping label groups (and optionally storing data for each shipping label group), shipping customers no longer have to keep track of shipments and shipping labels that need to be manifested.

Second, by virtue of using shipping carrier manifest requirements to assign labels to groups or to generate manifest information for a group, manifest errors can be reduced, thereby minimizing risk of shipping delay.

Further benefits are provided by the system and method disclosed herein.

### 3. System.

The system functions to automatically generate manifest information.

The system can be any suitable system that has access to data needed to automatically generate manifest information. The system can be a local (e.g., on-premises) system, a cloud-based system, or any combination of local and cloud-based systems. The system can be a single-tenant system, a multi-tenant system, or a combination of single-tenant and multi-tenant components.

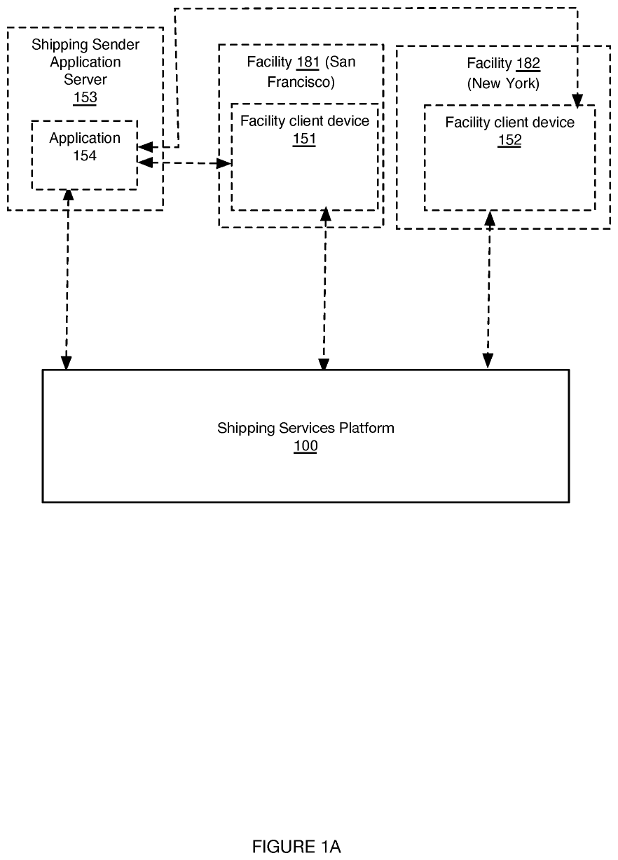

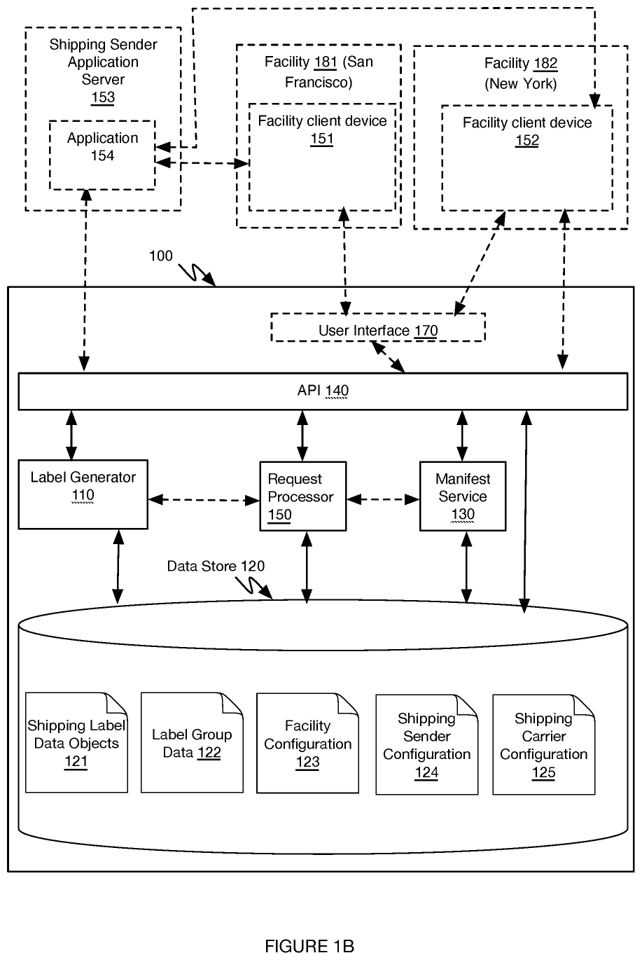

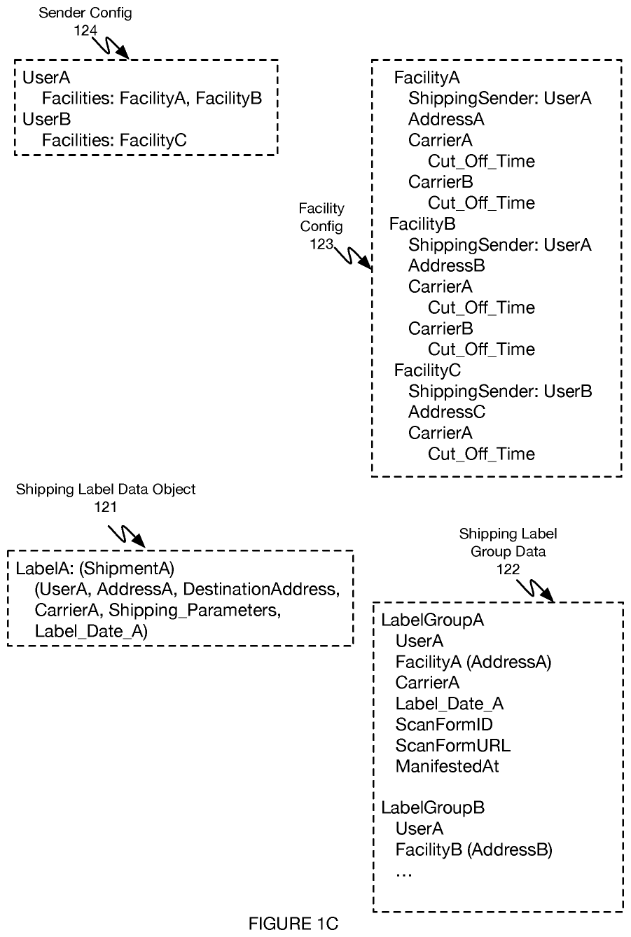

In some variations, the system is a shipping services platform (e.g., 100 shown in FIGS. 1A and 1B). In variants, the shipping services platform includes an application programming interface (API) (e.g., 140 shown in FIG. 1B). In some implementations, the API functions to process API requests for parcel shipping and logistics processes functionality. Applications (e.g., 154 running on an application server 153, shown in FIGS. 1A and 1B,) created by application developers can interface with the API (e.g., 140) to perform one or more shipping-related process. Shipping related processes can include one or more of: verifying addresses, purchasing shipping, tracking packages, and insuring shipments. However, any suitable shipping-related process can be performed by using the shipping services platform's API 140.

In variants, computing systems of shipping carriers can integrate with the shipping services platform via the API (e.g., 140). In some implementations, shipping carrier computing systems can access the API 140 to provide one or more of: shipping service information provided by the carrier (e.g., including rates, service levels, etc.), shipping label generation information, tracking information, shipping requirements (including manifest requirements, etc.), or any other suitable carrier-related data.

In variants, access to the API 140 is authenticated by using authentication information that is associated with a platform account (e.g., a parent user account, a child parent account, a shipping carrier's platform account, etc.). The authentication information can be an API key, or any other suitable type of authentication information. The API 140 can be used to perform configuration for a platform account (e.g., configure a user, configure a shipping carrier account, configure a facility, etc.) or retrieve data stored by the shipping services platform (e.g., information stored for a user, etc.). In variants, authentication information for a platform account can be used to access the API 140 from one or more client computing devices.

In an example, an online store application (e.g., 154) can process several purchase requests (e.g., thousands a day) by sending a shipping request for each purchased item to a respective shipping facility (e.g., via a facility client computing device 151, 152). In some cases, a purchase request includes several items, and the items can be shipped from different shipping facilities. Each facility client computing device (e.g., 151, 152) can use authentication information for a platform account to send a respective shipment request to the API 140 of the shipping services platform.

In variants, functionality provided by the shipping services platform can be accessed via a user interface (e.g., 170 shown in FIG. 1B).

In some variations, the system includes a request processor 150. The request processor 150 functions to process shipment requests. In some implementations, the request processor 150 uses the label data generator 110 to generate a shipping label (or data that can be used to generate a shipping label) in response to a shipment request received via the API 140.

In some variations, the request processor 150 functions to generate shipping label data objects (e.g., 121 shown in FIG. 1C). In variants, each shipping label data object includes a shipment identifier. In some implementations, at least one shipping label data object includes data that can be used to generate a shipping label. In some implementations, at least one shipping label data object includes a link (or reference) to a shipping label. In some implementations, at least one shipping label data object includes a digital representation of a shipping label (e.g., an image file, a portable document format (PDF) file), a bitmap file, etc.). However, a shipping label data object can otherwise include data for accessing a shipping label for a shipment represented by the shipping label data object.

In some implementations, the request processor 150 generates shipping label data objects in response to a shipping request (e.g., 301 shown in FIGS. 3A and 3B) received via the API 140. In some implementations, the request processor 150 generates shipping label data objects for a selected shipping carrier (e.g., identified by the shipping request, identified by configuration, etc.). The request processor 150 can use information stored in a data store (e.g., 120) to generate shipping label data objects. Such information can include one or more of: shipping facility configuration 123 (e.g., address of shipping facility that sends the shipment), shipping sender configuration 124, and shipping carrier configuration 125 (e.g., shown in FIG. 1B). However, the request processor 150 can use any suitable information to generate shipping label data objects.

In variants, the request processor 150 stores the shipping label data objects at the data store 120 (e.g., as shown in FIGS. 3A and 3B).

In variants, the shipping services platform 100 includes a manifest service 130. In some variations, the manifest service 130 functions to automatically generate manifest information for shipping facilities. However, in other variants, any suitable component of the shipping services platform 100 (e.g., the label generator 110, the request processor 150, etc.) can be used to generate manifest information.

In some implementations, the manifest service 130 is communicatively coupled to the data store 120, and can access information stored in the data store 120 (e.g., shipping label data objects 121, label group data 122, facility configuration 123, sender configuration 124, and carrier configuration 125). In some implementations, the manifest service 130 uses information stored in the data store 120 to automatically generate manifest information for shipping facilities (e.g., S240 shown in FIGS. 3A and 3B). In some implementations, the manifest service 130 generates manifest state information and stores manifest state information in the data store 120.

In a first variant, a shipping label data object 121 identifies at least one of: a shipping sender platform account, a sending address, a sending facility, a destination address, a shipping carrier, a shipping carrier service, shipping parameters, and a label date.

In a second variant, a shipping label data object 122 identifies at least one of: a shipping sender platform account, a facility, a facility address, a shipping carrier account, a shipping carrier, a shipping carrier service, a label date, manifest information, a reference to manifest information, and a time at which the manifest information was generated.

In variants, facility configuration 123 for a facility identifies at least one of: a shipping sender platform account associated with the shipping facility, an address of the shipping facility, each shipping carrier used by the facility, carrier account information for at least one carrier used by the facility, and manifest configuration for at least one shipping carrier used by the shipping facility. In variants, the manifest configuration includes at least one of a cut-off-time (e.g., “Cut_Off_Time”), and a manifest generation rule.

In variants, sender configuration 124 for a shipping sender identifies at least one of: a shipping sender platform account, and facilities configured for the sender.

In variants, shipping carrier configuration 125 identifies at least one of: shipping label requirements, shipping label format, a link to a label generation module (e.g., an API resource provided by a computing system of the shipping carrier, computer-executable instructions for generating a shipping label for the shipping carrier, etc.), manifest requirements, or any other suitable information. In variants, the system 100 generates shipping carrier configuration 125 in response to information received via the API 140. In some implementations, the shipping services platform generates manifest requirements for at least one shipping carrier based on data received via the API 140. In some implementations, the shipping services platform generates manifest requirements for at least one shipping carrier based on historical data. In some implementations, the historical data identifies manifest information errors received by the shipping services platform 100 from at least one shipping carrier. However, the system 100 can generate shipping carrier configuration 125 (and manifest requirements for shipping carriers) in any suitable manner.

FIG. 1C shows exemplary data stored in the data store 120.

In some variations, at least one component of the system performs at least a portion of the method disclosed herein.

In some variations, one or more of the components of the system are implemented as a hardware device that includes one or more of a processor (e.g., a CPU (central processing unit), GPU (graphics processing unit), NPU (neural processing unit), etc.), a display device, a memory, a storage device, an audible output device, an input device, an output device, and a communication interface. In some variations, one or more components included in hardware device are communicatively coupled via a bus. In some variations, one or more components included in the hardware system are communicatively coupled to an external system via the communication interface.

The communication interface functions to communicate data between the hardware system and another device via a network (e.g., a private network, a public network, the Internet, and the like).

In some variations, the storage device includes the machine-executable instructions for performing at least a portion of the method 200 described herein.

In some variations, the storage device includes the data included in the data store 120.

The input device functions to receive user input. In some variations, the input device includes at least one of buttons and a touch screen input device (e.g., a capacitive touch input device).

### 4. Method.

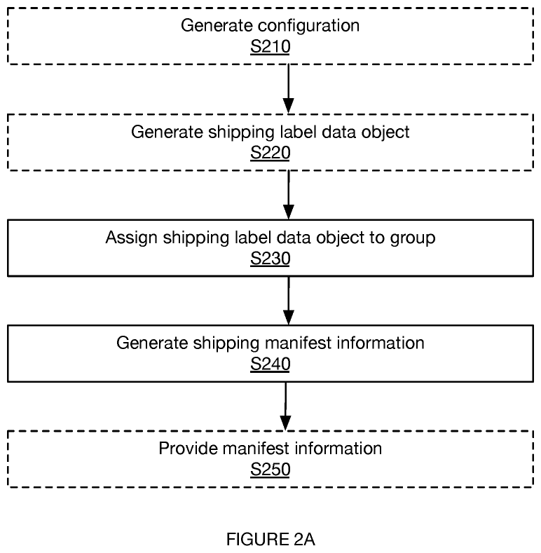

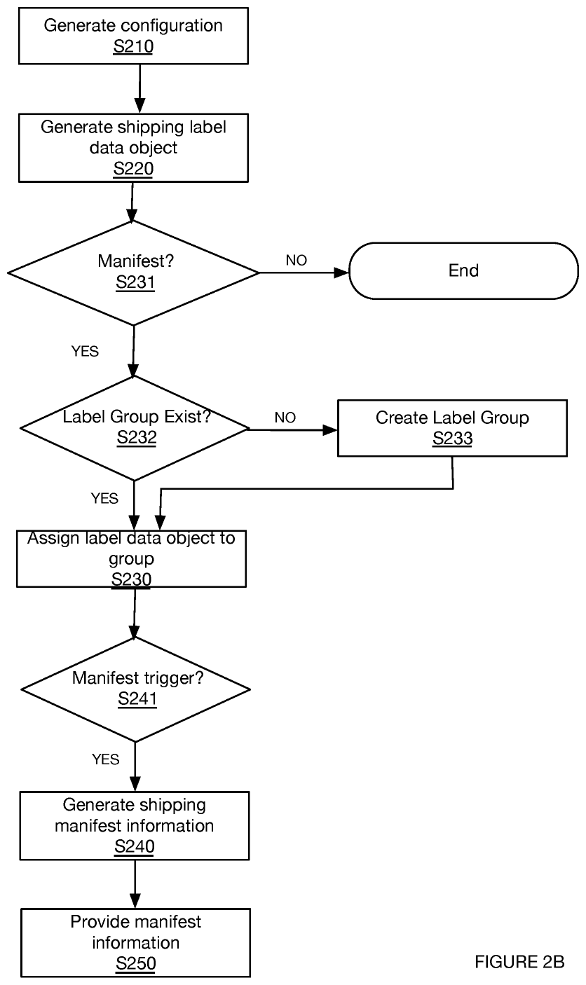

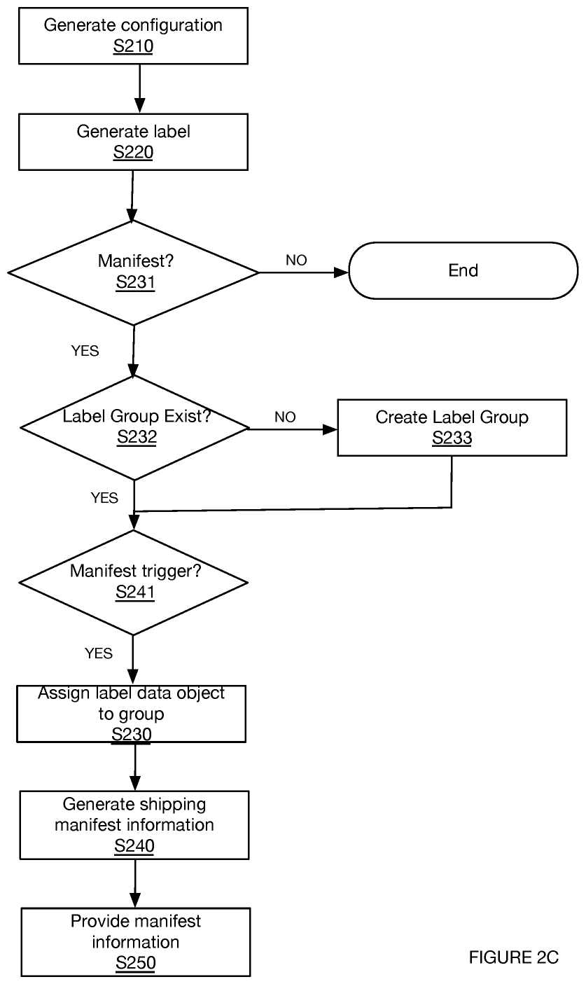

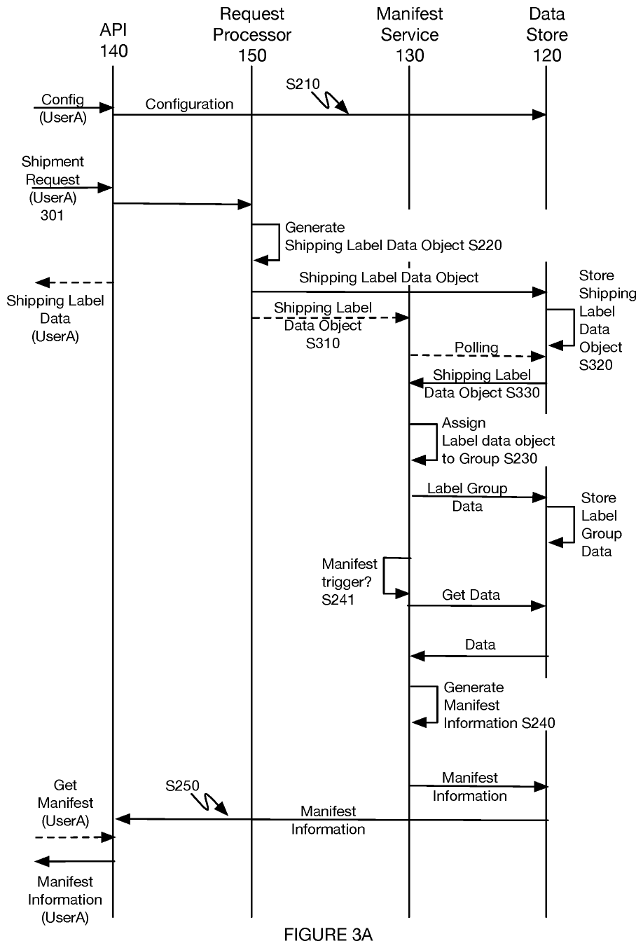

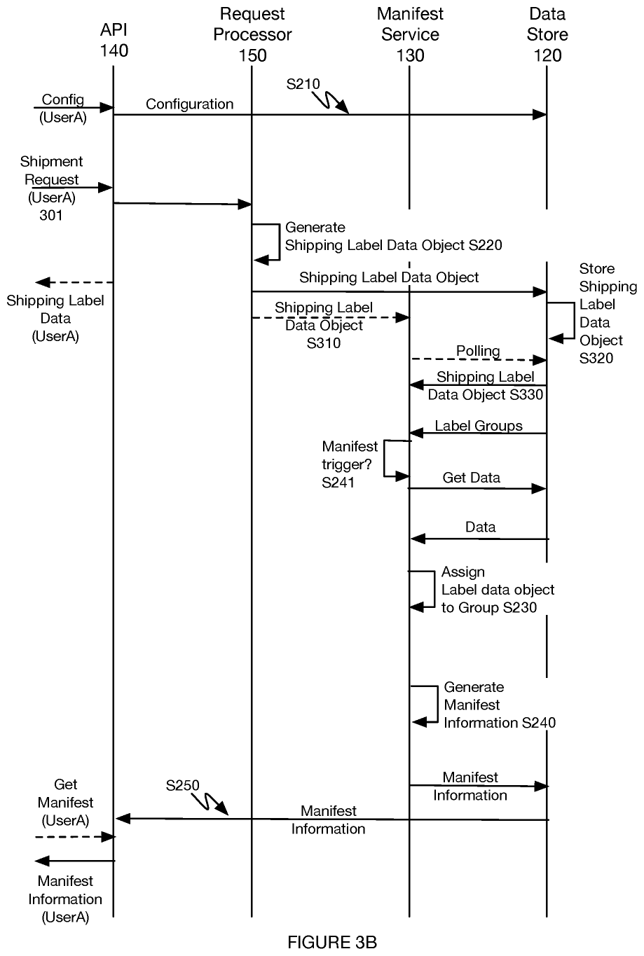

FIG. 2A is a representation of the method 200, according to variations.

The method 200 can include one or more of: assigning at least one shipping label data object to a shipping label group S230, and generating shipping manifest information S240. The method can optionally include one or more of: generating configuration S210, generating one or more shipping label data objects S220, and providing manifest information S250. In some variations, at least one component of the system 100 performs at least a portion of the method 200.

The method can be performed to generate manifest information for several platform accounts.

Generating configuration S210 can include generating configuration (e.g., facility configuration 123) for manifest generation for at least one shipping carrier used by at least one shipping facility (e.g., 181, 182 shown in FIGS. 1A and 1B). For example, one or more shipping facilities can be associated with a platform account (e.g., a shipping sender platform account). One or move shipping carriers can be configured for use by a shipping facility. For example, a shipping facility can have carrier accounts for several shipping providers (e.g., United States Postal Service, United Parcel Service, Federal Express, etc.). These carrier accounts can be used to buy shipping labels. Manifest generation can be configured for a shipping carrier used by a shipping facility, such that shipping labels used for shipments shipped from the facility by using the shipping carrier are automatically manifested.

In variants, the system 100 generates shipping facility configuration in response to information received via the API 140 (e.g., as shown in FIGS. 3A and 3B). However, the system 100 can generate shipping facility configuration in any suitable manner. In an example, an operator at a shipping facility 181 can use a client computing device 151 to access the shipping platform 100 (via the API 140) to set the shipping facility configuration for the shipping facility 181. The client computing device 151 can provide a configuration request to the system 100 via the API 140, and the configuration request can include authentication information for a platform account associated with the shipping facility 181.

In some implementations, shipping facility configuration for a shipping facility identifies an address of the shipping facility (e.g., AddressA, AddressB, etc.) and a platform account (e.g., UserA) (e.g., for a shipping sender) that is associated with the facility. In some implementations, the shipping facility configuration identifies each shipping carrier (e.g., CarrierA, CarrierB) that can be used for shipments from the shipping facility. In some implementations, the shipping facility configuration identifies account information for each shipping carrier (e.g., CarrierA, CarrierB) that can be used for shipments from the shipping facility. By using account information configured for a shipping carrier, the shipping services platform 100 can buy shipping labels on behalf of the shipping services platform account. In variants, the shipping facility configuration identifies manifest configuration for at least one of the shipping carriers used by the shipping facility. Shipping facility configuration can be specified by an operator of the facility (e.g., by using a facility client computing device 151, 152).

In a first variant, manifest configuration information identifies a cut-off time of the shipping facility for a corresponding shipping carrier.

In a second variant, manifest configuration information identifies a manifest generation rule of the shipping facility for a corresponding shipping carrier. A manifest generation rule can specify a trigger or event that triggers generation of a manifest of the facility for the corresponding shipping carrier.

In some implementations, one or more of the API 140 and the data store 120 generate configuration at S210.

Generating one or more shipping label data objects S220 functions to generate shipping label data objects for one or more platform accounts.

In variants, the system 100 generates shipping label data objects in response to information received via the API 140. However, the system 100 can generate shipping label data objects in any suitable manner. In an example, an operator at a shipping facility 181 can use a client computing device 151 to access the shipping platform 100 (via the API 140) to request one or more shipping labels for use by the shipping facility 181. The client computing device 151 can provide a shipping label request (e.g., 301 shown in FIGS. 3A and 3B) to the system 100 via the API 140, and the shipping label request can include authentication information for a platform account associated with the shipping facility 181.

In variants, generating a shipping label data object S220 includes generating a shipping label data object (e.g., 121) for at least one shipping label. In some implementations, a shipping label data object for a shipping label identifies one or more of: a platform account, a shipping sender address, a destination address, a carrier account identifier, a shipping carrier identifier, a shipping label date, and one or more shipping parameters. In some implementations, the shipping label data object includes one or more of: a digital representation (e.g., a QR code, bar code, watermark, etc.) of a shipping label; and a link to the digital representation. Shipping parameters can include one or more of a shipping service level and a service rate for an associated shipping carrier. In some implementations, a shipping label data object identifies a shipping facility that will use the shipping label data object (e.g., to print a shipping label, etc.). Alternatively, or additionally, the system 100 uses the shipping sender address included in the shipping label data object to identify the shipping facility. For example, the shipping services platform 100 can search the facility configuration 123 for facility information that matches the shipping sender address. However, the shipping facility can otherwise be identified.

In variants, the system 100 generates a shipping label data object in response to a shipping request (e.g., 301) that identifies a shipping carrier, and the system uses shipping carrier configuration 125 stored for the shipping carrier to generate the shipping label. The shipping carrier configuration 125 can include one or more of: shipping label requirements, shipping label format, a link to a label generation module (e.g., an API resource provided by a computing system of the shipping carrier, computer-executable instructions for generating a shipping label for the shipping carrier, etc.), manifest requirements, or any other suitable information.

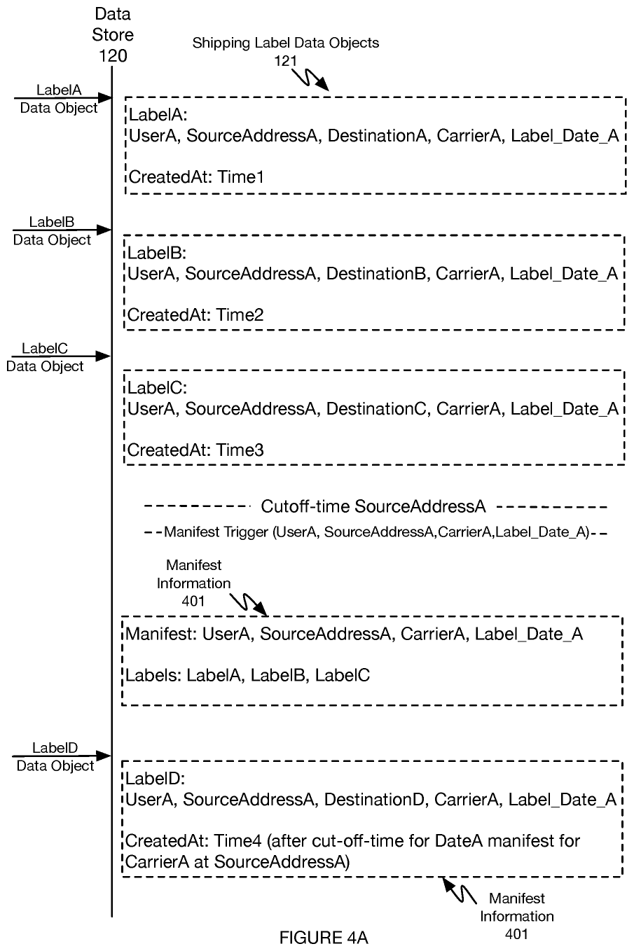

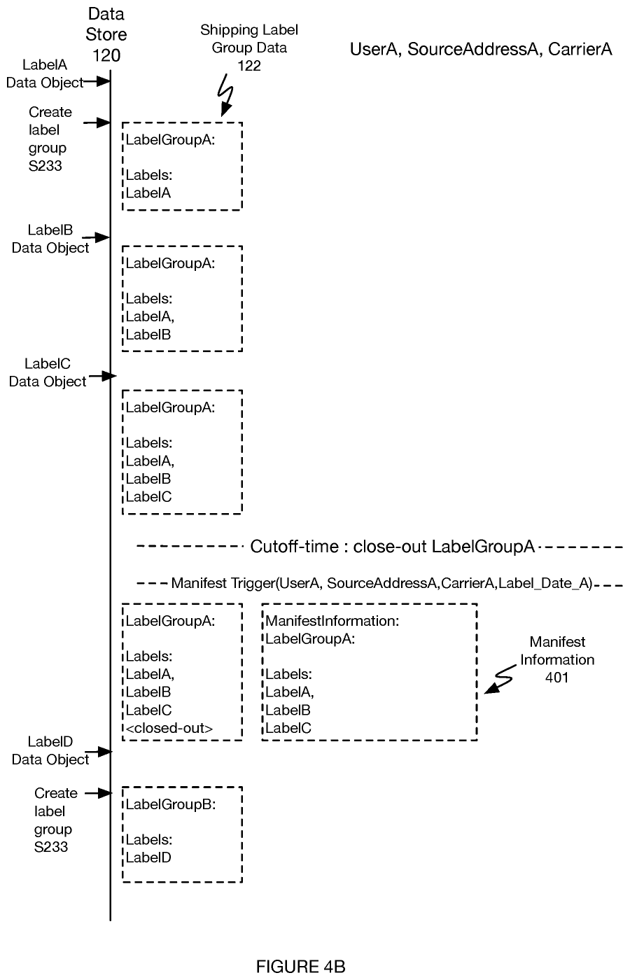

In some variations, the system 100 stores shipping label data objects at the data store 120 (e.g., as shown in FIGS. 3A and 3B) (S320 shown in FIGS. 3A and 3B). FIG. 4A shows exemplary shipping label data objects 121 stored at the data store 120 in response to generation of data objects for shipping labels A, B, C and D.

In some variations, the system 100 provides at least a portion of the information included in the shipping label data object to the manifest service 130.

In some implementations, one or more of the API 140, the label generator 110, the request processor 150, and the data store 120 generate shipping label data objects for at least one shipping label at S220. In an example, the request processor 150 generates a shipping label data object in response to a request received via the API 140, and stores the shipping label data object at the data store. In some variations, the request processor 150 provides at least a portion of the information included in shipping label data object (e.g., a shipment identifier) to the manifest service 130 (e.g., S310 shown in FIGS. 3A and 3B) (e.g., directly, or indirectly via another component). Additionally, or alternatively, the manifest service 130 monitors the data store 120 for new shipping label data objects and accesses the shipping label data object from the data store 120 (e.g., S330 shown in FIGS. 3A and 3B).

Assigning at least one shipping label data object to a shipping label group S230 functions to track shipments that are going to be manifested. Shipping label data objects can be assigned to shipping label groups at any suitable time, and in response to any suitable trigger.

In a first variant (example shown in FIGS. 2B and 3A), a shipping label data object is assigned to a shipping label group when the shipping label data object is generated. Assigning the shipping label data object to a shipping label group can include adding the shipping label data object to a list of shipping label data objects included in the label group. FIG. 4B shows exemplary shipping label group data 122 stored at the data store 120 in response to generation of data objects for shipping labels A, B, C and D.

In a second variant (example shown in FIGS. 2C and 3B), a shipping label data object is assigned to a shipping label group during generation of manifest information (e.g., in response to a manifest trigger). Assigning a shipping label data object to a shipping label group during manifest generation can include: executing a shipping label group query that returns all shipping label data objects that match attributes of the shipping label group being manifested.

However, shipping label data objects can be assigned to shipping label groups at any suitable time and in any suitable manner.

In variants, the system 100 determines whether a shipping label data object generated at S220 is to be manifested (e.g., at S231 shown in FIGS. 2B-C), and if so, the system 100 tracks the shipping label data object so that it can be manifested. In some implementations, the system 100 determines whether a shipping label data object is to be manifested at S231 by searching for manifest configuration for the shipping label data object (e.g., stored in the data store 120 as shipping facility configuration 123). In an example, the system 100 searches the facility configuration 123 stored in the data store 120 to determine whether the data store 120 includes manifest configuration that matches the shipping carrier, sender shipping address, and platform account of the shipping label data object. If manifest configuration exists, then the shipping label data object is to be manifested.

In some implementations, the manifest service 130 accesses shipping label data objects and determines (at S231) whether each accessed shipping label data object is to be manifested. The manifest service 130 can access the shipping label data objects from the request processor 150, or from the data store 120. In a first example, the manifest service 130 polls the data store 120 for new shipping label data objects 121 (e.g., S330 shown in FIGS. 3A and 3B). In a second example, the request processor 150 provides the manifest service 130 with a notification each time a shipping label data object is generated (e.g., S310 shown in FIGS. 3A and 3B). In a third example, the data store 120 provides the manifest service 130 with a notification each time a shipping label data object is stored (e.g., at S330). However, determining whether a shipping label data object is to be manifested can be performed in any suitable manner.

In variants, if the shipping label data object is to be manifested (“YES” at S231 shown in FIGS. 2B and 2C), the system 100 determines whether a shipping label group exists for the label (S232).

In some implementations, the system 100 determines whether a shipping label group exists for the label at S232 by searching shipping label group data 122 stored in the data store 120 to determine whether the data store 120 includes label group data for an open label group that matches the label date, shipping carrier, sender shipping address, and platform account of the shipping label data object. In variants, manifest state information recorded for the shipping label groups identifies whether the group is open or closed out. In some implementations, the manifest state information includes a link to a manifest (e.g., “ScanFormURL” shown in FIG. 1C) generated for the label group (if it exists). In some implementations, the manifest state information includes a manifest identifier (e.g., “ScanFormID” shown in FIG. 1C) for a manifest generated for the label group (if it exists). In some implementations, the manifest state information includes a manifest time (e.g., “ManifestedAt” shown in FIG. 1C) that identifies a time at which the manifest was generated. However, the manifest state information can include any suitable information. In an example, a group is open if a manifest has not been generated for the group.

In some implementations, shipping parameters are also used to determine whether a matching open label group exists for the shipping label data object. In some implementations, manifest requirements (e.g., included in shipping carrier configuration 125) for the shipping carrier associated with the shipping label data object are used to determine whether a matching label group exists for the shipping label data object. For example, some shipping carriers may place restrictions on which types of shipping labels (e.g., service types) for the carrier can be combined in a single manifest. As another example, some shipping carriers may place restrictions on the number of shipping labels that can be combined in a single manifest. By using a shipping carrier's manifest requirements to determine whether a label group exists for a shipping label data object, the system 100 can avoid assigning the shipping label data object to a label group that would result in an invalid manifest, thereby causing shipping delays.

If an open label group does exists for the shipping label data object (“YES” at S232), then the shipping label data object is assigned to the open label group at S230,

If an open label group does not exist for the shipping label data object (“NO” at S232), then a new label group is created for the shipping label data object at S233, and the shipping label data object is assigned to the new label group at S230. Creating a shipping label group can include storing label group data 122 for the label group at the data store 120. In variants, label group data includes one or more of: a label group identifier, a platform account identifier, a shipping facility identifier, a shipping facility address, a shipping carrier identifier, a label date, a list of identifiers for shipping label data objects included in the label group, and manifest state information.

FIG. 4A shows shipping label data objects 121 stored at the data store in response to generation of shipping label data objects for LabelA, LabelB, LabelC, and LabelD. FIG. 4B shows shipping label group data 122 stored at the data store in response to assigning the shipping label group data objects for LabelA, LabelB, LabelC, and LabelD to respective shipping label groups. As shown in FIG. 4B, the data store 120 does not initially include label group data for an open label group that matches the shipping label data object “LabelA” (which is associated with UserA, SourceAddressA, and CarrierA). Accordingly, at S233, a new label group (“LabelGroupA”) is created for UserA, SourceAddressA, and CarrierA. The shipping label data object “LabelA” is added to the label group “LabelGroupA”. When the shipping label data object “LabelB” is generated for UserA, SourceAddressA, and CarrierA, the shipping label data object “LabelB” is added to the label group “LabelGroupA”. When the shipping label data object “LabelC” is generated for UserA, SourceAddressA, and CarrierA, the shipping label data object “LabelC” is added to the label group “LabelGroupA”. After the cut-off time for UserA, SourceAddressA, and CarrierA, the label group “LabelGroupA” is closed out, and the manifest state information for the label group “LabelGroupA” is updated to identify the label group as being closed out.

In response to a manifest trigger (e.g., shown in FIG. 4A, 4B), manifest information 401 is generated for the label group “LabelGroupA”.

When the shipping label data object “LabelD” is generated for UserA, SourceAddressA, and CarrierA, the label group “LabelGroupA” is closed out, and the data store 120 does not include label group data for another open label group that matches the shipping label data object “LabelD”. Accordingly, at S233, a new open label group (“LabelGroupB”) is created for UserA, SourceAddressA, and CarrierA. The shipping label data object “LabelB” is added to the label group “LabelGroupB”.

Manifest information can be generated for a shipping label group (at S240) at any suitable time. In variants, the manifest information for a label group is generated in response to a manifest trigger (S241). In a first variation, the manifest trigger is a request received via the API 140. The manifest information can be generated in response to a request received from a shipping sender via the API 140. In a second variation, the manifest trigger is generated in response to satisfaction of a manifest generation rule. The manifest information can be automatically generated based on a manifest generation rule, without requiring a shipping sender to provide a request via the API 140. However, manifest information can otherwise be generated.

Any suitable component of the shipping services platform 100 can generate the manifest information at S240. In variants, the manifest service 130 generates the manifest information.

In some variations, the shipping services platform accesses the facility configuration 123 (e.g., shown in FIG. 1C) stored at the data store 120 to generate the manifest information for one or more shipping label groups. In an example, each shipping label group is associated with a facility (e.g., 181, 182); for each shipping label group, the manifest service 130 accesses the facility configuration 123 for the associated facility (e.g., from the data store 120), and uses the accessed facility configuration 123 to determine whether to generate manifest information for the shipping label group. In variants, the facility configuration 123 for a facility includes manifest configuration for at least one shipping carrier. The manifest configuration can be used to determine when, and how, to generate manifest information for a specific shipping carrier.

In a first example, the manifest configuration for a shipping carrier configured for a facility identifies a cut-off-time.

In a second example, the manifest configuration for a shipping carrier configured for a facility identifies at least one manifest generation rule. For example, some carriers might require the shipping sender to generate a separate manifest for each day, and the manifest generation rule triggers generation of a manifest for a shipping label group at the end of each day. Optionally, the manifest generation rule triggers generation of a second manifest for the shipping label group before a cut-off-time for the shipping carrier. In other words, for a carrier with a cut-off time of 4 pm, two manifests would be generated for a same shipping label data group: 1) a first manifest would be generated for shipment label data objects added to the group after 4 pm and before 12am on that day, and 2) a second manifest would be generated for shipment label data objects added to the group after 12 am and before 4 pm. However, manifests can otherwise be generated in accordance with manifest configuration.

In variants, the shipping services platform 100 generates manifest information for at least one shipping label group according to manifest requirements (e.g., included in shipping carrier configuration 125) for the shipping carrier associated with the shipping label data object. The manifest requirements can specify rules for determining when to generate manifests, format for manifests, or any other suitable information that can be used by the shipping services platform 100 to generate manifest information that complies with requirements of the associated shipping carrier. By virtue of using shipping carrier manifest requirements to generate manifest information for a group, manifest errors can be reduced, thereby minimizing risk of shipping delay.

In variants, shipping manifest information (e.g., 401 shown in FIGS. 4A and 4B) for a shipping label group identifies each shipping label data object included in the shipping label group. In a first example, the shipping manifest information for a shipping label group is a SCAN form. In a first example, the shipping manifest information for a shipping label group is a bill of lading. However, shipping manifest information can include any suitable content, and have any suitable format.

Generating the manifest information at S240 can include recording (by using the shipping services platform 100) label group manifest state information for the label group for which the manifest information is being generated. In an example, the manifest state information for a shipping label group includes information that identifies whether manifest information has been generated for the shipping label group. The manifest state information recorded for a shipping label group can be used identify open label groups that can be assigned to shipping label data objects at S230.

Manifest information generated by the shipping services platform 100 can be provided in any suitable manner at S250. The shipping services platform can provide the manifest information to any suitable system at S250. Such systems can be external to the shipping services platform 100. In a first example, the shipping services platform 100 provides generated manifest information for a shipping carrier to a shipping carrier computing system (e.g., a United States Postal Service, United Parcel Service, Federal Express computing system, etc.) for the shipping carrier. The manifest information can have any suitable format. In an example, manifest information provided to a shipping carrier computing system has a computer-readable format. Manifest information can be provided to a shipping carrier computing system in any suitable manner (e.g., via a private network, via a public network, via a direct communication link, etc.).

In a second example, the shipping services platform 100 provides generated manifest information for a shipping carrier to a computing system of a shipping sender platform account (e.g., 151 shown in FIG. 1A). The manifest information can have any suitable format (e.g., an image, a portable document format (PDF), bitmap, etc.). The computing system of the shipping sender platform account can control a printer to print the manifest information, and the printed manifest information can be presented by a facility operator during pick-up of packages to be delivered by the associated shipping carrier service.

In variants, the shipping services platform 100 provides shipping group information for at least one shipping label group to a computing system of a shipping sender platform account. In some implementations, the shipping group information identifies at least one of the following for a shipping label group: shipping sender platform account, shipping facility identifier, shipping carrier identifier, shipping label date, manifest information, manifest time, manifest identifier, and shipping label data object for at least one shipping label data object. In a first example, the shipping services platform 100 provides the shipping group information as a response to a request received via the API 140. In a second example, the shipping services platform 100 provides the shipping group information via a notification sent by a notification system. However, the shipping services platform 100 can provide the shipping group information to computing systems in any suitable manner.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the disclosed embodiments without departing from the scope of this disclosure defined in the following claims.

1. A system for generating shipping manifest information comprising:
individually-controlled shipping sender platform accounts, wherein at least one shipping facility is associated with each shipping sender platform account;
a facility client device of a shipping facility, generating a shipping request associated with a shipping carrier;
a multi-tenant shipping services platform account coupled to the facility client device and the network, the shipping services platform configured to:
with an application programming interface (API) of the platform, receiveing a configuration request from a client device via a network, wherein the configuration request includes authentication information for the shipping sender platform account;
with the API, automatically authenticate the configuration request based on the authentication information;
with at least one of the API and a data store of the platform, generate facility configuration for at least one shipping facility of the shipping sender platform account, based on the authenticated configuration request;
with the API, determine manifest information error data based on a communication with a computing system of a shipping carrier via the network;
based on the manifest information error data, automatically generate manifest requirements for the shipping carrier;
with the API, receive, via the network, the shipping request from the facility client device, wherein the shipping request identifies the shipping carrier;
with a request processor of the platform, generate a shipping label data object for the shipping sender platform account encoding data from the shipping request;
with a manifest service of the platform, automatically update a shipping label group within the data store of the platform, comprising: assigning the generated shipping label data object to the shipping label group based on shipping facility, shipping carrier, and label date of the shipping label data object;
based on update the shipping label group, detect a manifest trigger for the shipping label group with the manifest service;
in response to detection of the manifest trigger for the shipping label group, automatically generate shipping manifest information for the shipping label group of the shipping sender platform account according to respective facility configuration and the generated manifest requirements for the shipping carrier; and
provide generated shipping manifest information of the shipping sender platform account to at least one system external to the shipping services platform.

2. The system of claim 1,
wherein facility configuration generated for at least one shipping facility of the shipping sender platform account identifies: an address of the shipping facility, each shipping carrier used by the facility, and manifest configuration for at least one shipping carrier used by the shipping facility, and
wherein automatically generateing shipping manifest information for each shipping label group according to respective facility configuration comprises: for at least one shipping label group, generating the shipping manifest information based on the manifest configuration for the shipping carrier associated with the shipping label group.

3. The system of claim 2, wherein manifest configuration identifies a cut-off-time, wherein the manifest trigger comprises a satisfaction of the cut-off-time.

4. The system of claim 2, wherein manifest configuration identifies a manifest generation rule.

5. The system of claim 2,
wherein provide generated shipping manifest information to at least one system external to the shipping services platform comprises: providing generated shipping manifest information for a shipping carrier to a shipping carrier computing system.

6. The system of claim 5, wherein the shipping manifest information provided to the shipping carrier computing system has a computer-readable format.

7. The system of claim 2,
wherein provideing generated shipping manifest information to at least one system external to the shipping services platform comprises: providing generated shipping manifest information for a shipping carrier to a computing system of the shipping sender platform account.

8. The system of claim 7, wherein the shipping manifest information provided to the computing system of the shipping sender platform account has a PDF (Portable Document Format) format.

9. The system of claim 2,
wherein the shipping services platform stores manifest requirements for at least one shipping carrier, and
wherein the shipping services platform automatically assigns shipping label data objects generated for the shipping sender platform account to the shipping label group based on manifest requirements for the shipping carrier associated with the shipping label group, and
wherein the shipping services platform automatically generates shipping manifest information for at least one shipping label group of the shipping sender platform account according to the respective facility configuration and manifest requirements for the shipping carrier associated with the at least one shipping label group.

10. (canceled)

11. The system of claim 9, wherein the shipping services platform generates manifest requirements for at least one shipping carrier, based on data received via the API.

12. (canceled)

13. The system of claim 1, wherein shipping manifest information for a shipping label group identifies each shipping label data object included in the shipping label group.

14. The system of claim 1, wherein shipping manifest information for a shipping label group comprises a shipping SCAN form.

15. The system of claim 1, wherein shipping manifest information for a shipping label group is a bill of lading.

16. The system of claim 1, wherein the multi-tenant-shipping services platform is further configured to record label group manifest state information for at least one shipping label group, wherein label group manifest state information for a shipping label group includes information that identifies whether manifest information has been generated for the shipping label group.

17. The system of claim i6, wherein automatically assigning the generated shipping label data object to a shipping label group comprises: assigning the shipping label data object to one or more groups for which manifest information has not already been generated, as indicated by the label group manifest state information.

18. The system of claim 7, wherein automatically assigning the generated_shipping label data object to a shipping label group comprises: generating a new shipping label group if an available shipping label group does not already exist.

19. The system of claim 1, wherein the multi-tenant shipping services platform is further configured to, for at least one shipping sender platform account: store shipping group information for each shipping label group; and provide shipping group information for at least one shipping label group to a computing system of the shipping sender platform account.

20. The system of claim 19, wherein shipping group information identifies at least one of the following for the shipping label group: shipping sender platform account, shipping facility identifier, shipping carrier identifier, shipping label date, manifest information, manifest time, manifest identifier, and shipping label data object for at least one shipping label.
